(19) United States
(12) Patent Application Publication
(10) Pub. No.: US 2026/0341264 A1
(43) Pub. Date: Oct. 29, 2026

(54) ACCURATE CONTROLLABLE ZERO-SHOT LARGE-LANGUAGE-MODEL-BASED TEXT-TO-SPEECH

(71) Applicants: SONY GROUP CORPORATION, Tokyo (JP); SONY CORPORATION OF AMERICA, New York, NY (US)

(72) Inventors: Patrick Lumbantobing, Burlingame, CA (US); Keiichi Osako, San Mateo, CA (US)

(21) Appl. No.: 19/188,865

(22) Filed: Apr. 24, 2025

(51) Int. Cl. G10L 13/027; G06F 40/40; G10L 13/10

(52) U.S. Cl. CPC G10L 13/027; G06F 40/40; G10L 13/10; G10L 2013/105

(57) ABSTRACT

A zero-shot TTS based on a large language model allows one model trained for different voice identities, wide range of expressivity, accents and various languages. A divide and conquer mechanism of reference voice embeddings can be used with respect to each voice attribute: voice identity, voice quality, expressivity, accent, speech duration and language. The model is enforced to perform right-on-target learning for each reference tokens set. The system can utilize engineered features for each stream, e.g., speaker verification features, acoustics spectrum, F0, energy, emotion recognition features, accent recognition features and speech duration. This allows the model to have a straightforward task to learn what specific attributes each embedding is tasked for, i.e., smaller but more accurate space to learn for each embedding instead of one mel-spectrogram embedding for all possible attributes. Consistency loss is further utilized to improve acoustics modeling and pronunciation robustness.

### BACKGROUND OF THE INVENTION

### 1. Field of the Invention

Embodiments of the invention relate generally to systems and methods of for providing text-to-speech (TTS). More particularly, embodiments of the invention relate to methods and systems for providing an accurate controllable zero-shot large language model (LLM)-based TTS.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Tools based on Large Language Models (LLMs, which incorporate an attention mechanism) have demonstrated remarkable natural language processing capabilities mimicking human linguistic or reasoning functions. LLMs have been used to answer questions, translate and summarize documents, or create content, and have found applications in finance, legal scholarship, programming, and chatbots. However, the usage of LLMs as everyday tools has been limited for a variety of reasons, such as computational burden and undesirable artifacts.

Text-to-speech (TTS) is a field of computer science concerning transforming textual and/or other data into audio data that is synthesized to resemble human speech. TTS systems read aloud digital text to a user and are becoming increasingly popular on mobile devices. Certain TTS models aim to synthesize various aspects of speech, such as speaking styles, to produce human-like, natural sounding speech. Synthesis in TTS models is a one-to-many mapping problem, as there can be multiple possible speech outputs for the different prosodies of text inputs. Many TTS systems utilize an autoregressive model that predicts current values based on previous values.

Recent years have witnessed a trend that large language model (LLM) based text-to-speech (TTS) emerges into the mainstream due to their high naturalness and zero-shot capacity. In this paradigm, speech signals are discretized into token sequences, which are modeled by an LLM with text as prompts and reconstructed by a token-based vocoder to waveforms. Obviously, speech tokens play a critical role in LLM-based TTS models.

In view of the foregoing, there is a need for improved systems and methods for improved and accurate TTS that have the capability to accurately reproduce reference voice on all attributes (such as identity, expressivity and accent), while further providing the capability to control each of these attributes.

### SUMMARY OF THE INVENTION

Embodiments of the present invention provide an accurate TTS that has the capability to accurately reproduce reference voice on all attributes (such as identity, expressivity and accent), while further providing the capability to control each of these attributes.

The TTS system, according to aspects of the present invention can be efficient in time and cost of TTS model production for different types of voices, expressivity, accents, languages and the like. The TTS system can provide accuracy in reproducing reference voice in zero-shot TTS models, covering voice identity, expressivity, accent and pronunciation accuracies. The TTS system can provide controllability in zero-shot TTS models, covering voice identity, expressivity and accent. The data requirement in the development of the LLM-based TTS, according to aspects of the present invention, are significantly lower than conventional models.

Embodiments of the present invention provide a method for synthesizing speech from text using a zero-shot text-to-speech model. Embodiments of the present invention further provide a computer-readable medium having computer readable code thereupon for performing the method. Further embodiments of the present invention include systems for performing the methods described herein. In some embodiments, the method comprises training a large language model (LLM) for different voice attributes, where the voice attributes include voice identity, voice quality, expressivity, accent, speech duration and language; performing audio reference voice embeddings for each voice attribute using a divide and conquer mechanism to generate audio reference tokens; training the LLM to recognize what task each audio reference voice embedding belongs using engineered features; and using the trained LLM to generate human speech from input text.

In some embodiments, which may be combined with the above embodiment, the method further comprises enforcing the LLM to perform right-on-target learning for each audio reference token.

In some embodiments, which may be combined with any of the above embodiments, the engineered features include speaker verification features, acoustics spectrum, F0, energy, emotion recognition features, accent recognition features and speech duration.

In some embodiments, which may be combined with any of the above embodiments, the method further comprises improving acoustics modeling and pronunciation robustness by using consistency loss with respect to a spectrum frequency and phonetic language sequence.

In some embodiments, which may be combined with any of the above embodiments, the LLM uses a generative pre-trained transformer (GPT).

In some embodiments, which may be combined with any of the above embodiments, the method further comprises introducing additional orthogonality loss to enforce orthogonality constraint between the audio reference embedding tokens.

In some embodiments, which may be combined with any of the above embodiments, the method further comprises increasing a purity of information for each stream with the introduced additional orthogonality loss.

In some embodiments, which may be combined with any of the above embodiments, different embedding sets represent different things without leaking one information to another and preventing controllability.

In some embodiments, which may be combined with any of the above embodiments, the training is performed within about 7,000 hours.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a pictorial representation showing how speech can vary between different speakers and with different emotion elements;

FIG. 2 illustrates a flow chart of text to human speech, where the identity / emotion / accent label is a fixed condition, without any variations or zero-shot capability;

FIG. 3 illustrates a flow chart of text to human speech, where an audio encoder is used to receive an audio reference to drive voice identification / expressivity / accent for zero-shot;

FIG. 4 illustrates a flow chart showing a large TTS / audio speech language model with a generative pre-trained transformer (GPT);

FIG. 5 illustrates a speech language audio model with voice mixer as used during training thereof;

FIG. 6 illustrates a speech language audio model with voice mixer as used at inference; and

FIG. 7 provides a functional block diagram illustration of a computer hardware platform that can be used to implement a particularly configured computing device that can perform text-to-speech, as herein described.

Unless otherwise indicated, the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term "and/or" includes any and all combinations of one or more of the associated listed items. As used herein, the singular forms "a," "an," and "the" are intended to include the plural forms as well as the singular forms, unless the context clearly indicates otherwise. It will be further understood that the terms "comprises" and/or "comprising," when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

A "computer" or “computing device” may refer to one or more apparatus and/or one or more systems that are capable of accepting a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

"Software" or “application” may refer to prescribed rules to operate a computer. Examples of software or applications may include code segments in one or more computer-readable languages; graphical and or/textual instructions; applets; pre-compiled code; interpreted code; compiled code; and computer programs.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

The term "computer-readable medium" as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G, 5G or the like.

Embodiments of the present invention may include apparatuses for performing the operations disclosed herein. An apparatus may be specially constructed for the desired purposes, or it may comprise a device selectively activated or reconfigured by a program stored in the device.

Unless specifically stated otherwise, and as may be apparent from the following description and claims, it should be appreciated that throughout the specification descriptions utilizing terms such as "processing," "computing," "calculating," "determining," or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term "processor" may refer to any device or portion of a device that processes electronic data from registers and/or memory to transform that electronic data into other electronic data that may be stored in registers and/or memory or may be communicated to an external device so as to cause physical changes or actuation of the external device.

As is well known to those skilled in the art, many careful considerations and compromises typically must be made when designing for the optimal configuration of a commercial implementation of any method or system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a zero-shot TTS based on a large language model, allowing one model trained for different voice identities, wide range of expressivity, accents, and various languages. A divide and conquer mechanism of reference voice embeddings can be used with respect to each voice attributes: voice identity, voice quality, expressivity, accent, speech duration and language;. Aspects of the present invention can develop one large model, and use it for all voices, even if they are not in the training data, i.e., zero-shot. The voice embeddings can be based on a divide and conquer mechanism because the methods can use explicit prompt for each voice traits, e.g., identity/acoustics/emotion/accent, instead of only one prompt. This way, the model learns different parts of voices explicitly, i.e., divide and conquer, and it is expected to have easier task rather than figuring them out from only one prompt.

The model is enforced to perform right-on-target learning for each reference tokens set. Right-on-target learning is the effect of using specific prompts for specific voice traits. Instead of having one large space for the model to learn the voice traits, i.e., with one prompt, aspects of the present invention cut them to pieces and tell the model what each piece is about, e.g., identity / acoustics / emotion / accent or the like. This way, it is a right-on-target learning, and the space to learn for each voice traits is compressed. Hence, the methods can catch outlier points, i.e., zero-shot, easier in a compressed space rather than in a one large space.

These engineered features can be tailored for the specific voice traits, i.e., voice identity, voice quality, expressivity, accent, and duration. Voice identity is encoded with the speaker embedding. Voice quality is encoded with the acoustics spectrum. Expressivity is encoded with F0, energy and emotion embedding. Accent is encoded with accent embedding. Speech duration is also encoded with a specific duration embedding. The acoustics spectrum, F0, energy, emotion recognition, and accent recognition features sequences can be processed with dedicated encoders called a Perceiver Encoder. This encoder utilizes self-attention mechanism that generates an embedding sequence with a fixed length from an input sequence with varying length. The speaker embedding and duration embedding are produced with linear layers.

The system can utilize engineered features for each stream, e.g., speaker verification features, F0, energy, emotion recognition features and accent recognition features.

This allows the model to have a straightforward task to learn what specific attributes each embedding is tasked for, i.e., smaller but more accurate space to learn for each embedding instead of one mel-spectrogram embedding for all possible attributes.

Consistency loss with respect to spectrum frequency and phonetic language sequence is further utilized, improving acoustics modeling and pronunciation robustness. The consistency loss can include spectrum, F0, energy and text losses. From the GPT last hidden state, aspects of the present invention use another network module to generate mel-spectrogram, F0, energy, and the logits of text tokens. The methods can compute L1 losses of the mel-spectrogram, F0, and energy. The methods can also compute the CTC (Connectionist Temporal Classification) loss between the logits of the text tokens and the text tokens. If these losses are not used, the outputs can be unstable, and so such losses can typically be used by default.

Based on the specific audio reference tokens streams from above, the system can introduce additional orthogonality loss to enforce orthogonality constraint between reference embedding tokens. The system can increase the purity of information for each stream, as orthogonality trait adheres to the independency between reference tokens, hence different embedding sets will represent different things instead of leaking one information to another and preventing controllability. The orthogonality loss is computed between the reference embedding tokens, such as between speaker and accent embeddings, between emotion and accent embeddings, between speaker and emotion embeddings, and so forth. For instance, the methods can compute the orthogonality loss between the speaker embedding and the accent embedding. Specifically, the methods can compute the cosine similarity between them, and minimize this loss in the optimization. The methods typically want to enforce orthogonality, i.e., to minimize the cosine similarity, Cosine of 0 degree is 1, which happens if two vectors are in the same direction. The methods want to make these two vectors apart from each other to enforce that each embedding represents different information. Hence, each embedding prompt will be accurate and controllable.

As a result of these techniques, the system can provide an accurate zero-shot LLM-based TTS with controllability on a relatively small amount of training dataset, such as about 7,000 hours. This can be compared to ordinary LLM TTS that requires at least 60,000 hours for training. This has the effect to provide a model that requires much smaller space for the learning of voice attributes for each reference token set. Hence, even with smaller amount of data, the learning of such task can be done accurately.

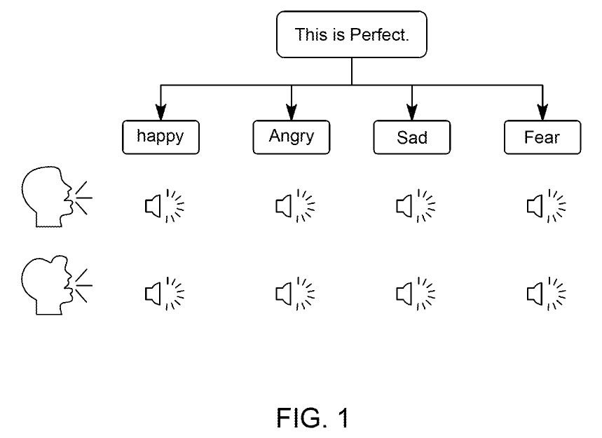

Referring to FIG. 1, it is illustrated how two different speakers can say the same phrase (such as “This is perfect”). Such a phrase may have different connotations and meanings to a listener depending on an expressivity or emotion aspect of the speech. A TTS zero-shot model that does not have expressive training data may result in these phrases sounding similar, even though different expressivity may be desired. Training a model for every new data is not efficient, however. Conventional TTS models either can perform enough for target data or can generalize enough (zero-shot) with an averaging performance. Aspects of the present invention provide a TTS model with excellent performance.

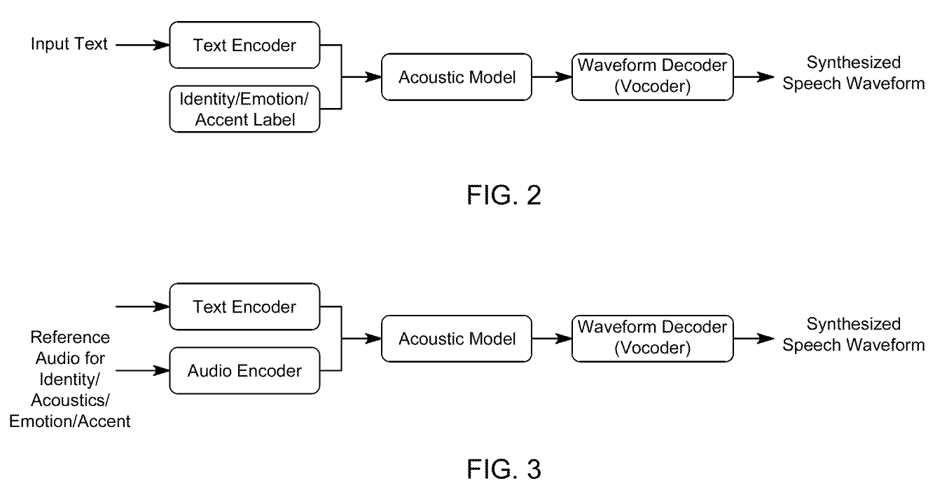

Referring to FIG. 2, in human speech production, an idea / concept (abstraction) becomes physical speech production (synthesis) which provides human speech. In TTs, text (abstraction) becomes an intermediate speech representation which them results in a speech waveform. More specifically, input text can be input to a text encoder, which, along with an optional identity / emotion / accent label, can identify a suitable acoustic model that can use a waveform decoder to generate speech. The identity / emotion / accent label, however, is a fixed condition and does not permit any variations / zero-shot capability.

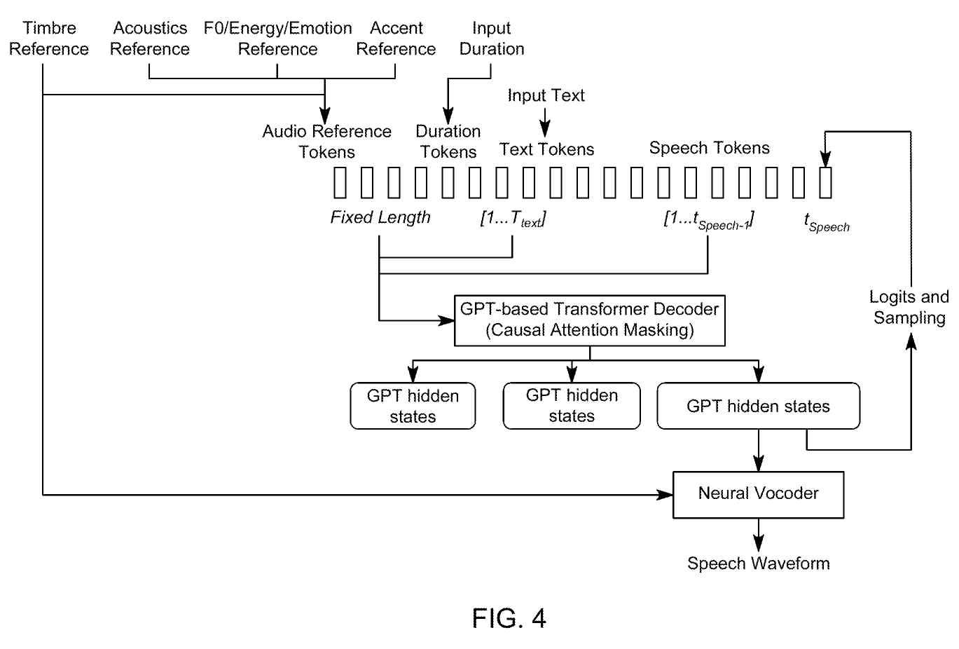

Referring to FIG. 3, through the use of an audio reference, the audio encoder can drive multiple voice attributes with excellent accuracy to output a synthesized speech waveform. FIG. 4 illustrates a large TTS / audio speech language model with GPT that can handle different streams of audio for specific voice attributes.

More specifically, FIG. 4 illustrates how the audio reference tokens can be taken from a plurality of different sources. Such sources can include a timbre references, acoustic references, F0 / energy / emotion references and accent references, for example. The input text may be provided as text tokens. Speech tokens can also be provided in the model, similar to conventional TTS models. A GPT-based transformer decoder can output a neural vocoder via one or more GPT hidden states.

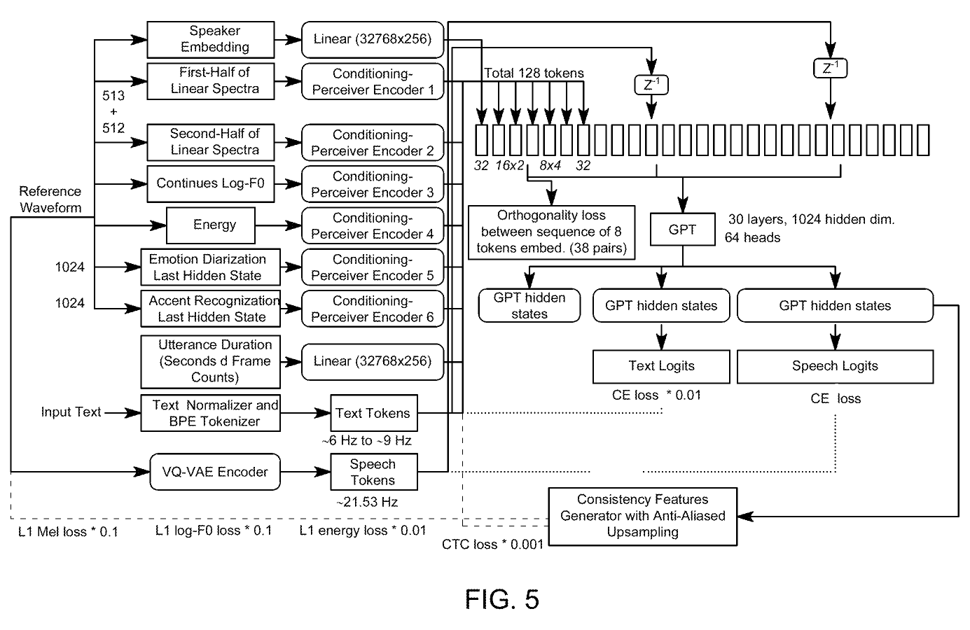

Referring to FIG. 5, in training the model of FIG. 4, the audio reference tokens can include speaker embedding, first-half of linear spectra, second half of linear spectra, continuous Log-F0, energy, emotion diarization last hidden state and accent recognition last hidden state. For the training, the data flow is as follows: The inputs are text and speech. Text is encoded into text tokens. Speech is encoded into different embedding streams, e.g., identity/emotion/accent, and into speech tokens. The time-step of the input text tokens sequence and input speech tokens sequence are shifted to the right because the process wants to predict the next time step. The outputs are also text and speech. Specifically the text tokens and the speech tokens sequence of the current time-step. The model is optimized with the cross-entropy losses of the text tokens and the speech tokens.

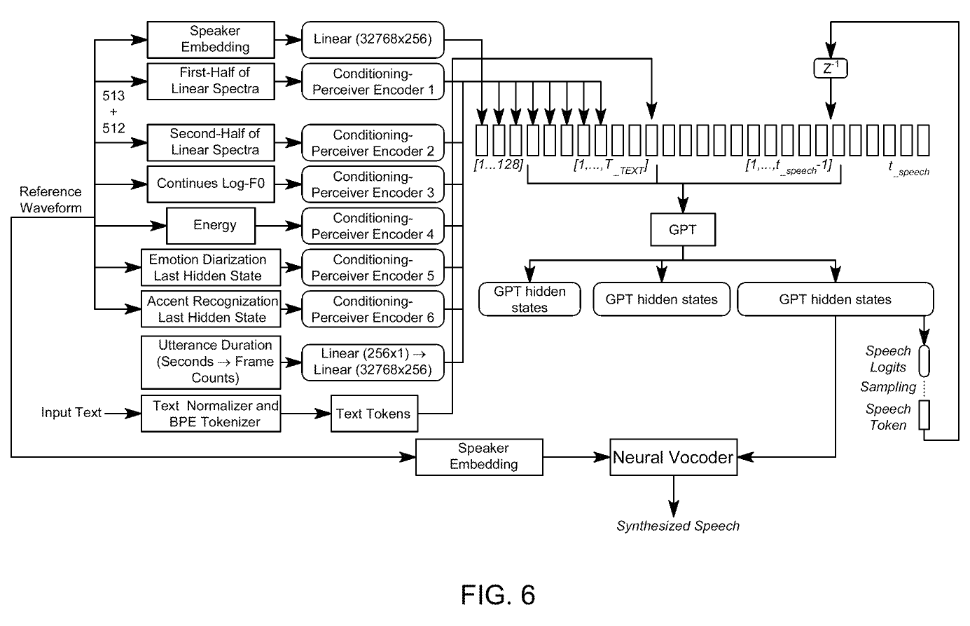

FIG. 6 shows the inference flow, where input data is provided as text tokens to the model to generate a speech waveform that provide an output synthesized speech waveform. For the inference, the data flow is as follows: The inputs are text and reference audios. Text is encoded into text tokens. Reference audios are encoded into different embedding streams, e.g., identity/emotion/accent. The output is the predicted speech tokens sequence. To generate the speech waveform, the GPT last hidden state, i.e., the layer just before the speech tokens output, is used as input to the neural vocoder, on which the speech waveform is generated.

### Example Computer Platform

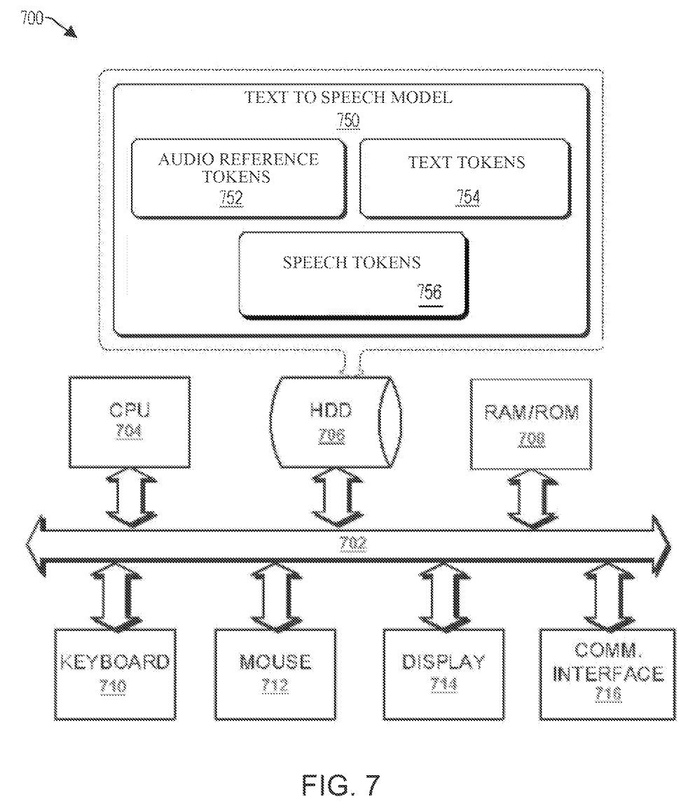

FIG. 7 provides a functional block diagram illustration of a computer hardware platform 700 that can be used to implement a particularly configured computing device that can provide a text to speech model 750. The text to speech model 750, as discussed above, can use audio reference tokens 752, a text tokes 754 from input text, and speech tokens 756 to provide synthesized speech.

The computer platform 700 may include a central processing unit (CPU) 702, a hard disk drive (HDD) 704, random access memory (RAM) and/or read only memory (ROM) 706, a keyboard 708, a mouse 710, a display 712, and a communication interface 714, which are connected to a system bus 716.

In one embodiment, the HDD 704, has capabilities that include storing a program that can execute various processes, such as the text to speech model 750, in a manner to perform the methods described herein.

Of course, the methods of the present invention may be carried out by various computing devices, including the computer hardware platform 700, described above, or may further be performed in a cloud computing system having resources for providing the text to speech model as discussed herein.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A method for synthesizing speech from text using a zero-shot text-to-speech model, comprising:
training a large language model (LLM) for different voice attributes, where the voice attributes include voice identity, voice quality, expressivity, accent, speech duration and language;
performing audio reference voice embeddings for each voice attribute using a divide and conquer mechanism to generate audio reference tokens;
training the LLM to recognize what task each audio reference voice embedding belongs using engineered features; and
using the trained LLM to generate human speech from input text.

2. The method of claim 1, further comprising enforcing the LLM to perform right-on-target learning for each audio reference token.

3. The method of claim 1, wherein the engineered features include speaker verification features, acoustics spectrum, F0, energy, emotion recognition features, accent recognition features and speech duration.

4. The method of claim 1, further comprising improving acoustics modeling and pronunciation robustness by using consistency loss with respect to a spectrum frequency and phonetic language sequence.

5. The method of claim 1, wherein the LLM uses a generative pre-trained transformer (GPT).

6. The method of claim 1, further comprising introducing additional orthogonality loss to enforce orthogonality constraint between the audio reference embedding tokens.

7. The method of claim 6, further comprising increasing a purity of information for each stream with the introduced additional orthogonality loss.

8. The method of claim 7, wherein different embedding sets represent different things without leaking one information to another and preventing controllability.

9. The method of claim 1, wherein the training is performed within about 7,000 hours.

10. A non-transitory computer readable storage medium tangibly embodying a computer readable program code having computer readable instructions that, when executed, causes a computer device to carry out a method of synthesizing speech from text using a zero-shot text-to-speech model, the method comprising:
training a large language model (LLM) for different voice attributes, where the voice attributes include voice identity, voice quality, expressivity, accent, speech duration and language;
performing audio reference voice embeddings for each voice attribute using a divide and conquer mechanism to generate audio reference tokens;
training the LLM to recognize what task each audio reference voice embedding belongs using engineered features; and
using the trained LLM to generate human speech from input text.

11. The non-transitory computer readable storage medium of claim 10, wherein the method further comprises enforcing the LLM to perform right-on-target learning for each audio reference token.

12. The non-transitory computer readable storage medium of claim 10, wherein the engineered features include speaker verification features, acoustics spectrum, F0, energy, emotion recognition features, accent recognition features and speech duration.

13. The non-transitory computer readable storage medium of claim 10, wherein the method further comprises improving acoustics modeling and pronunciation robustness by using consistency loss with respect to a spectrum frequency and phonetic language sequence.

14. The non-transitory computer readable storage medium of claim 10, wherein the LLM uses a generative pre-trained transformer (GPT).

15. The non-transitory computer readable storage medium of claim 10, wherein the method further comprises introducing additional orthogonality loss to enforce orthogonality constraint between the audio reference embedding tokens.

16. The non-transitory computer readable storage medium of claim 15, wherein the method further comprises increasing a purity of information for each stream with the introduced additional orthogonality loss.

17. The non-transitory computer readable storage medium of claim 16, wherein different embedding sets represent different things without leaking one information to another and preventing controllability.

18. The non-transitory computer readable storage medium of claim 10, wherein the training is performed within about 7,000 hours.

19. A system comprising:
a processor;
a memory coupled to the processor; and
a computer readable storage embodying a computer program code, the computer program code comprising instructions for synthesizing speech from text using a zero-shot text-to-speech model, the instructions executable by the processor and configured to :
train a large language model (LLM) for different voice attributes, where the voice attributes include voice identity, voice quality, expressivity, accent, speech duration and language;
perform audio reference voice embeddings for each voice attribute using a divide and conquer mechanism to generate audio reference tokens;
train the LLM to recognize what task each audio reference voice embedding belongs using engineered features; and
use the trained LLM to generate human speech from input text.
